(19) United States
(12) Patent Application Publication
(10) Pub. No.: US 2010/0000433 A1
(43) Pub. Date: Jan. 7, 2010

(54) Method for bonding slider row bars for photolithography process and method for manufacturing sliders

(75) Inventors: YongPing Gao, Dongguan (CN); TaiBoon Lee, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 12/216,255

(22) Filed: Jul. 1, 2008

(51) Int. Cl. B41M 3/00

(52) U.S. Cl. 101/463.1

(57) ABSTRACT

A method for bonding slider row bars for photolithography process includes steps of: (1) forming a holding device having a sticky surface; (2) providing a plurality of slider row bars each of which has a first surface for forming air bearing surface and a second surface opposite to the first surface, and attaching the slider row bars on the holding device with the first surfaces of the slider row bars facing to the sticky surface; (3) heating the holding device with the slider row bars attached thereon and pressing the second surfaces of the slider row bars to push the slider row bars into the sticky surface; (4) bonding the slider row bars together by an encapsulating glue to form a slider row bar assembly; (5) providing a carrier and bonding the carrier to the second surfaces of the slider row bars; and (6) removing the holding device. The invention also discloses a method for manufacturing sliders.

### FIELD OF THE INVENTION

The present invention relates to a method of manufacturing sliders used in information recording disk drive units, and more particularly to a method of bonding slider row bars for photolithography process in manufacturing the sliders.

### BACKGROUND OF THE INVENTION

One known type of information storage device is a disk drive device that uses magnetic media to store data and a movable read/write head that is positioned over the magnetic media to selectively read from or write to the rotating magnetic media, such as a magnetic disk.

FIG. 1a illustrates a conventional disk drive device 200 and shows a magnetic disk 101 mounted on a spindle motor 102 for spinning the disk 101. A voice coil motor arm 104 carries a head gimbal assembly (HGA) 100 that includes a micro-actuator 105 and a slider 103 incorporating a read/write head. A voice-coil motor (VCM) is provided for controlling the motion of the motor arm 104 and, in turn, controlling the slider 103 to move from track to track across the surface of the disk 101, thereby enabling the read/write head to read data from or write data to the disk 101. In operation, a lift force is generated by the aerodynamic interaction between the slider 103 and the spinning magnetic disk 101. The lift force is opposed by equal and opposite spring forces applied by a suspension of the HGA 100 such that a predetermined flying height above the surface of the spinning disk 101 is maintained over a full radial stroke of the motor arm 104.

FIG. 1b illustrates a perspective view of the slider shown in FIG. 1a in a bottom view. As illustrated, a magnetic reading/writing head 116, which is used for realizing data reading/writing operation of the slider relative to the disk 101, is formed on one side surface of the slider 103. The slider 103 has an air bearing surface (ABS) 117 facing to the disk 101. When the disk drive device is in operation, an aerodynamic interaction is generated between the ABS 117 of the slider 103 and the rotary disk 101 in a high speed, thus making the slider 103 floating over the disk 101 dynamically to perform data reading/writing operation.

To make the slider read data from or write data to the disk successfully, the slider is required to have a good flying stability, i.e. the flying height of slider is kept at an invariable value when the slider is flying over the disk. If the slider has a bad flying stability, the flying height is variable, i.e. sometimes the flying height becomes higher and sometimes the flying height becomes lower. If the flying height is too high, the slider may not successfully realize a read/write operation; if the flying height is too low, the slider may scratch the disk to cause a damage of the disk and/or the slider.

Understandably, manufacturing accuracy of the ABS of the slider is a key factor to influence the flying stability of the slider. Here, a process of forming the ABS of the slider is described briefly as follows. Generally, the ABS of the slider is formed by photolithography process and vacuum etching process in sequence. At first, a photo-resist coating is covered on an ABS-forming surface of the slider; then, an air bearing surface pattern (ABS pattern) are transferred to the photo-resist coating by exposure to form a removable region according to the ABS pattern; next, the photo-resist coating is developed to get rid of the removable region of the photo-resist coating; and finally, portions of the ABS-forming surface uncovered by the photo-resist coating is etched by ion beam to form an ABS.

In related art, a manufacturing process of the slider is typically based on a plurality of slider row bars, each of which is constructed by a plurality of slider bodies. A slider row bar may comprise 30-100 slider bodies according to different product type. These slider row bars are encapsulated together by adhesive to form an entire row bar assembly. After being processed, these row bar assemblies are separated from each other and finally each of these row bar assemblies is cut into separate sliders.

FIGS. 2a-2b show a slider row bar used for forming sliders. As shown in the figures, the slider row bar 2 has a width W and a thickness T. The slider row bar 2 has an ABS-forming surface 3. FIG. 2c shows a carrier 1 for holding the slider row bars 2.

A row bar assembly formed by one of the conventional bonding methods is shown in FIGS. 3a-3b. FIG. 3a shows a plurality of slider row bars 2 encapsulated together and bonded onto the carrier 1. FIG. 3b shows a cross-sectional view of FIG. 3a taken along line Z-Z. Referring to FIG. 3b, a plurality of encapsulating adhesive recesses 30 are formed in a plurality of gaps (not labeled) between the slider row bars 2. The encapsulating adhesive recesses 30 are formed by natural shrinkage of the encapsulating adhesive 9 during curing process. Referring to FIG. 3a and FIG. 3b, the ABS-forming surfaces 3 of the slider row bars 2 and the encapsulating adhesive recesses 30 form a base surface of the slider row bar assembly on which a photo-resist coating will be covered.

Also referring to FIG. 3b, it is easily to understand that the flatness of the base surface of the slider row bar assembly is mainly determined by two factors: the encapsulating adhesive recesses 30 and thickness uniformity of the slider row bars 2. First, as the slider row bars 2 have a small thickness (about 100˜300 microns), it is very difficult to improve thickness uniformity of the slider row bars 2. On the other hand, the encapsulating adhesive recesses 30 are unavoidable due to the inherent character of the encapsulating adhesive 9. In the conventional slider row bar bonding process, because each of the slider row bars 2 and the bonding adhesive 5 thereunder has a different thickness (i.e. the slider row bars 2 and the bonding adhesive 5 thereunder has a thickness variation), and there are the encapsulating adhesive recesses 30, the flatness of the base surface of the slider row bar assembly is decreased seriously. Furthermore, though the bonding adhesive thickness can vary according to the row bar thickness variation, the row bar thickness variation impact can not be completely compensated by the adhesive thickness variation. For example, when row bars thickness variation is 30 microns, the flatness of the base surface of the row bar assemblies may over 10 or 20 microns which is insufficient to accommodate thin, high resolution photo-resist coating. Accordingly, a photo-resist coating formed on the base surface of the slider row bar assembly has a bad flatness.

In addition, the bonding adhesive volume control is critical in the prior method, which may cause process unstable or manufacturing cost increasing. Insufficient or too much bonding adhesive may cause troubles for the following encapsulation process which is necessary for row bar side surfaces protection during ion milling etching or reactive ion etching. Insufficient bonding adhesive produces some room or cavity between row bars and the support substrate. The cavity may trap some air or encapsulating adhesive which can not be cured by ultraviolet light because usually the row bars and the support substrate are nontransparent for ultraviolet light. The air or uncured encapsulating adhesive may come out and cause defect or yield loss in the photolithography process which includes a necessary baking (about 70˜120° C.) process. Too much bonding adhesive means some bonding adhesive comes into the gaps between row bars, which may block encapsulating adhesive to fully fill the gaps between row bars, and the mixture of the bonding adhesive and the encapsulating adhesive may form adhesive protrusion between slider row bars which is hard to removed, in turn, the manufacturing cost is increased.

Thus, it is desired to provide a method for bonding slider row bars for photolithography process to overcome the above-mentioned drawbacks.

### SUMMARY OF THE INVENTION

One objective of the invention is to provide a method for bonding slider row bars for photolithography process which can make the ABS-forming surface of the slider row bars flat and eliminate the seepage of encapsulating adhesive onto the ABS-forming surface of the slider row bars, and eliminate the protrusion caused by the mixing of the bonding adhesive and encapsulating adhesive which is hard to remove.

Another objective of the invention is to provide a method for manufacturing sliders, which can improve manufacturing accuracy of the sliders.

To achieve the above objectives, a method for bonding slider row bars with protrusion free encapsulation for photolithography process, comprises steps of: (1) forming a holding device having a sticky surface; (2) providing a plurality of slider row bars each of which has a first surface for forming ABS and a second surface opposite to the first surface, and attaching the slider row bars on the holding device with the first surfaces of the slider row bars facing to the sticky surface; (3) heating the holding device with the slider row bars attached thereon, and pressing the second surfaces of the slider row bars to push the slider row bars into the sticky surface; (4) bonding the slider row bars together by an encapsulating glue to form a slider row bar assembly; (5) providing a carrier and bonding the carrier to the second surfaces of the slider row bars; and (6) removing the holding device.

In one embodiment of the method according to the present invention, the holding device in the step (1) is formed by steps of: (a) providing a frame having an hole therein; (b) providing a film having a sticky layer serving as the sticky surface and a non-sticky layer laminated together with the sticky layer, and covering the film on the frame with the sticky layer facing to the frame; (c) providing a vacuum transfer fixture having a base plate and a protrusion stage which is protruded from the base plate and has a plurality of vacuum holes defined therein; and (d) assembling the vacuum transfer fixture to the frame with the protrusion stage received in the hole of the frame and contacting with the non-sticky layer of the film.

Preferably, after the step (1), the method further comprises a step of evacuating spaces defined by the protrusion stage and the non-sticky layer to generate air pressure to press the film against the protrusion stage.

In another embodiment of the method according to the present invention, the step (3) comprises steps of: (a) providing a hot plate and putting the holding device on the hot plate; (b) providing a container and placing the container on the holding device with a bottom surface of the container contacting the second surfaces of the slider row bars; and (c) after a period of time, removing the container and the holding device from the hot plate in sequence and cooling the holding device to a temperature near ambient temperature.

Preferably, the container is filled with fluid inside and sealed, and the container has an elastic thin film on the bottom surface thereof which contacts the second surfaces of the slider row bars.

Preferably, before placing the container on the holding device, the container is pre-heated to a temperature as high as the hot plate, and the temperature of the hot plate is in the range of from 50˜110° C.

In another embodiment of the method according to the present invention, the step (4) comprises steps of: (a) providing a glue-restraining plate having an opening and attaching the glue-restraining plate to the sticky surface of the holding device such that the slider row bars are exposed from the opening; (b) dispensing the encapsulating glue into the opening of the glue-restraining plate; (c) laminating the encapsulating glue dispensed in the opening of the glue-restraining plate such that the encapsulating glue flows into spaces defined between the slider row bars; and (d) curing the encapsulating glue such that all the slider row bars are bonded together.

In another embodiment of the method according to the present invention, the step (5) comprises steps of: (a) providing a kind of fast-curing glue and dispensing the fast-curing glue to the second surfaces of the slider row bars; and (b) attaching the carrier to the second surfaces of the slider row bars via the fast-curing glue.

In still another embodiment of the method according to the present invention, the step (6) comprises steps of: (a) removing the vacuum transfer fixture from the frame; and (b) removing the film from the slider row bars.

In further another embodiment of the method according to the present invention, an elastic layer is sandwiched between the carrier and the second surfaces of the slider row bars to absorb shrinkage stress generated by the fast-curing glue.

A method for manufacturing sliders comprises steps of: (1) forming a holding device having a sticky surface; (2) providing a plurality of slider row bars each of which has a first surface for forming ABS and a second surface opposite to the first surface, and attaching the slider row bars on the holding device with the first surfaces of the slider row bars facing to the sticky surface; (3) heating the holding device with the slider row bars attached thereon, and pressing the second surfaces of the slider row bars to push the slider row bars into the sticky surface; (4) bonding the slider row bars together by an encapsulating glue to form a slider row bar assembly; (5) providing a carrier and bonding the carrier to the second surfaces of the slider row bars; (6) removing the holding device to expose the first surfaces of the slider row bars; (7) etching the first surfaces of the slider row bars to form air bearing surfaces; (8) cutting the slider row bars into separate sliders.

Compared with the prior art, because it is the ABS-forming surfaces of the slider row bars, not the slider-mounting surfaces thereof are taken as a datum plane, an influence caused by thickness variation of the slider row bars is reduced, or even eliminated completely. In addition, the sticky surface of the holding device is softened after heated, and by pressing the second surfaces of the slider row bars, the softened sticky surface enables the first surfaces of the slider row bars to be pushed thereinto, thus the possible seepage of the encapsulating glue onto the first surfaces of the slider row bars can be avoided. More important, usually a mixed layer which is hard to be removed exists between the sticky layer and the encapsulating glue because of the sticky layer dissolving in the encapsulating glue; by pressing and pushing the slider row bars into the sticky layer the mixed layer can be moved into the spaces between the slider row bars, which results in no protrusion between the slider row bars. That is to say, the flatness of the ABS-forming surfaces of the slider row bars assembly (the bonded slider row bars) is improved greatly so that the sliders manufactured by the method of the invention may have an excellent flying stability, and thus the disk drive has a good flying performance, and there is no fear that the disk and/or the slider may be damaged.

Moreover, since the ABS-forming surface of the slider row bars are pressed firmly on the protrusion stage of the fixture, glue shrinkage at the ABS-forming surfaces is baffled by the protrusion stage, and thus glue recess happens mainly at the second surfaces (slider-mounting surfaces) of the row bars, and therefore, influence caused by the glue recess on the overall flatness of the ABS-forming surfaces is reduced greatly.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1a is a perspective view of a conventional disk drive device;

FIG. 1b is a perspective view of a slider of the disk drive device shown in FIG. 1a;

FIG. 2a is a perspective view of a slider row bar used in a slider row bar bonding process;

FIG. 2b is an enlarged view of portion A of the slider row bar shown in FIG. 2a;

FIG. 2c is a perspective view of a carrier used in a conventional process of bonding slider row bar;

FIG. 3a shows a plurality of slider row bars encapsulated together and bonded on the carrier shown in FIG. 2b by a conventional method;

FIG. 3b shows a cross-sectional view of FIG. 3a taken along line Z-Z;

FIG. 4 shows a flow chart illustrating a process of bonding a plurality of slider row bars together according to an embodiment of the invention;

FIGS. 5a-5d are sequential views illustrating a process of forming a holding device for temporarily holding a plurality of slider row bars thereon;

FIGS. 6a-6c are sequential views illustrating a process of attaching a plurality of slider row bars on the holding device formed by the process shown in FIGS. 5a-5d;

FIG. 7 shows a process of heating, pressing and pushing the first surface of slider row bars into the sticky surface of the holding device;

FIG. 8 shows a cross-sectional view of FIG. 7 taken along line S-S after the heating and pressing process;

FIGS. 9a-9d sequentially show a set of views illustrating a process of encapsulating the slider row bars together, the slider row bars being carried on the holding device by process shown in FIGS. 6a-6c;

FIGS. 10a-10b show a process of mounting a carrier onto the backside of the slider row bars which are encapsulated together by the process shown in FIGS. 9a-9d;

FIGS. 11a-11d show a process for removing the holding device;

FIG. 12 shows two surface scanning characteristics of a slider row bar assembly respectively formed by the conventional method and the present method illustrated in an embodiment of the invention;

FIG. 13 shows a glue recess generated in the processing surface of a plurality of slider row bars which are encapsulated by conventional slider row bar bonding method;

FIG. 14 shows a glue recess generated in the processing surface of the slider row bar assembly which are bonded by a slider row bar bonding method of the invention; and

FIG. 15 shows a flow chart illustrating a slider manufacturing process according to an embodiment of the invention.

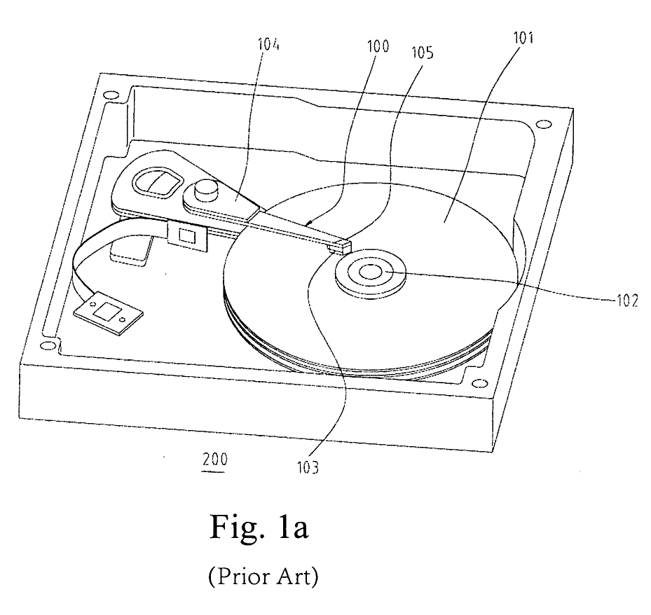

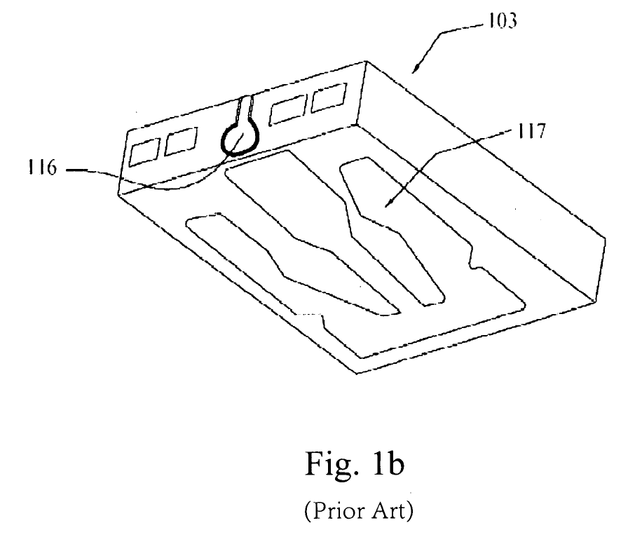

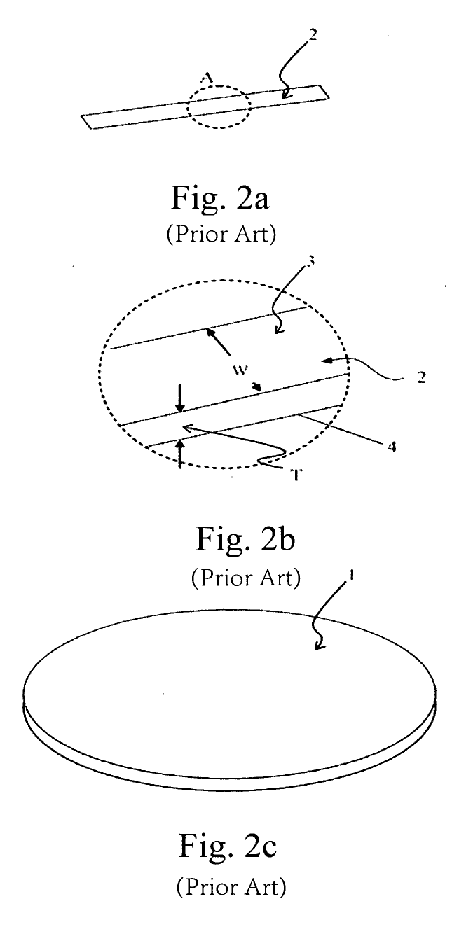

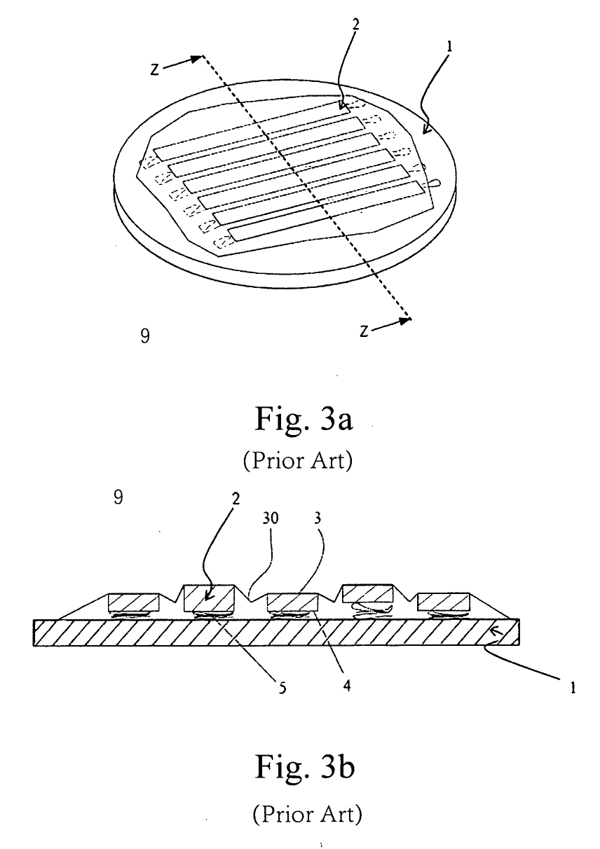

### DETAILED DESCRIPTION OF THE INVENTION

Various preferred embodiments of the invention will now be described with reference to the figures, wherein like reference numerals designate similar parts throughout the various views.

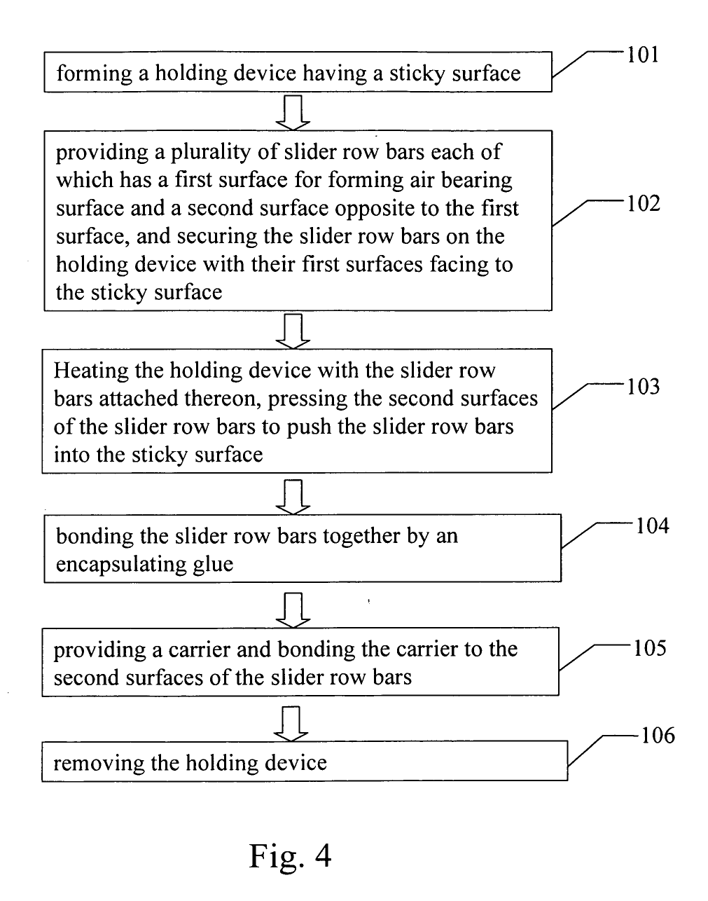

As indicated above, the invention is directed to a method for bonding slider row bars for photolithography process. Referring to FIG. 4, a method for bonding slider row bars for photolithography process comprises steps of: forming a holding device having a sticky surface (step 101); providing a plurality of slider row bars each of which has a first surface for forming ABS and a second surface opposite to the first surface, and attaching the slider row bars on the holding device with their first surfaces facing to the sticky surface (step 102); heating the holding device with the slider row bars attached thereon, and pressing the second surfaces of the slider row bars to push the slider row bars into the sticky surface (step 103); bonding the slider row bars together by an encapsulating glue to form a slider row bar assembly (step 104); providing a carrier and bonding the carrier to the second surfaces of the slider row bars (step 105); and removing the holding device (step 106).

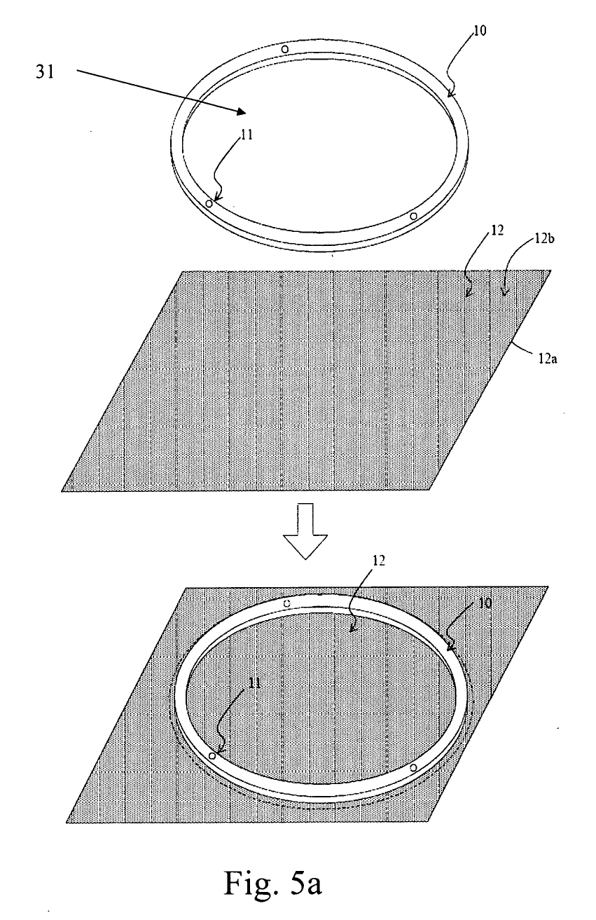

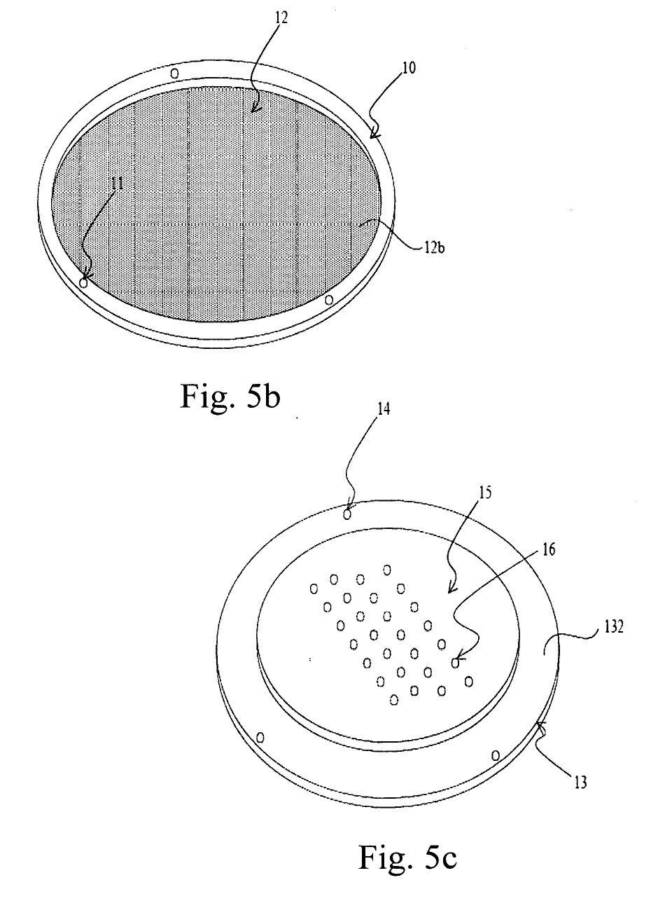

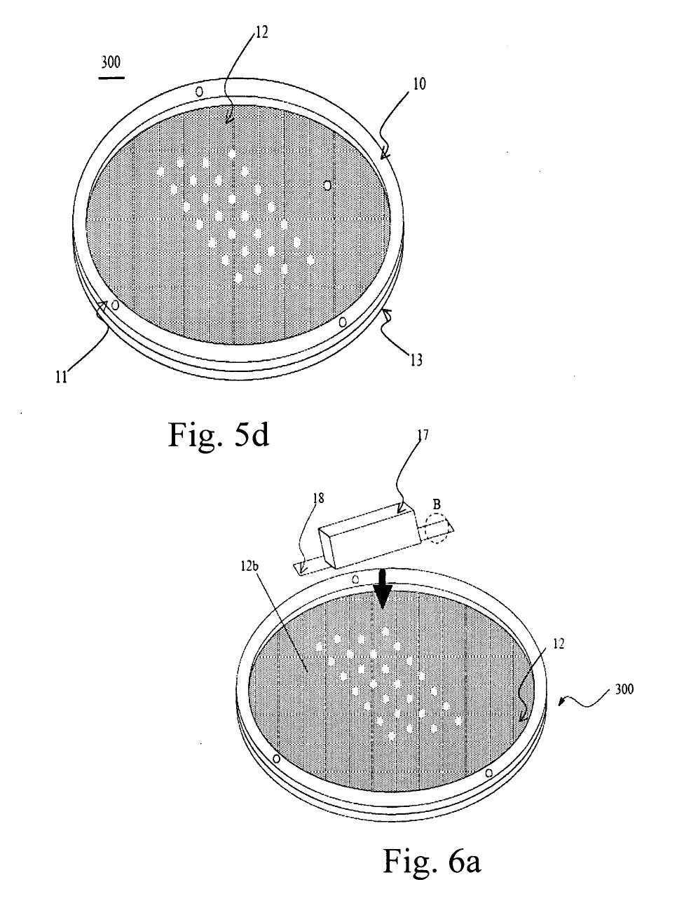

FIGS. 5a-5d illustrate the step to form the holding device in the step 101 of the method above-mentioned. As shown in FIG. 5a, a frame 10 having a hole 31 defined therein and a plurality of screw holes 11 formed on its perimeter is provided, and this frame 10 may be made of any rigid material, such as steel or ceramic so as to provide sufficient stiffness. A film 12 that comprises a sticky layer 12b and a non-sticky layer 12a laminated with the sticky layer 12b is provided also. The film 12 is attached to the frame 10 by attaching its sticky layer 12b to the frame 10 so that the hole 31 of the frame 10 is completely covered by the film 12. Then, as shown in FIG. 5b, a part of the film 12 beyond the perimeter of the frame 10 is cut away such that the film 12 has a shape consistent with the frame 10.

Next, as shown in FIGS. 5c-5d, a vacuum transfer fixture 13 is provided. The vacuum transfer fixture 13 has a base plate 132 and a protrusion stage 15 extended from the base plate 132. Corresponding to the screw holes 11 of the frame 10, a plurality of screw holes 14 is formed on the perimeter of the base plate 132. A plurality of vacuum holes 16 are formed in the protrusion stage 15. The vacuum transfer fixture 13 is then assembled to the frame 10 with the protrusion stage 15 received in the hole 31 (referring to FIG. 5a) and covered by the non-sticky layer 12a (referring to FIG. 5a) of the film 12, thus forming a holding device 300. The vacuum transfer fixture 13 may be assembled to the frame 10 using a plurality of bolts (not shown) which screwing in respective screw holes 11 and 14. Finally, spaces defined between the vacuum holes 16 of the vacuum transfer fixture 13 and the film 12 are evacuated by suitable device, for example a pump, to generate air pressure to press the film 12 against the protrusion stage 15.

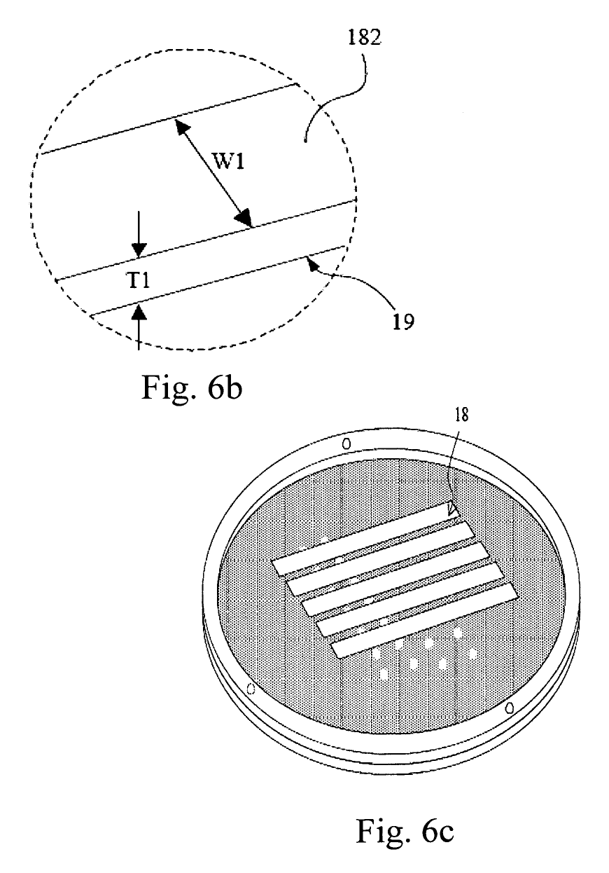

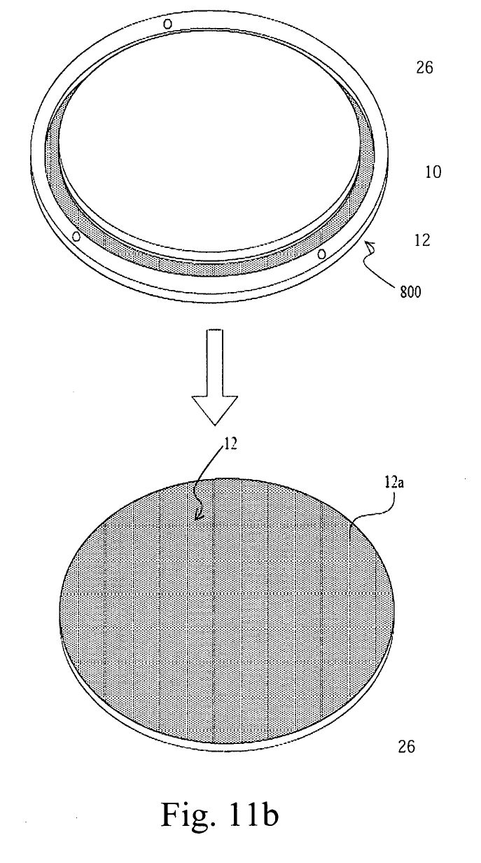

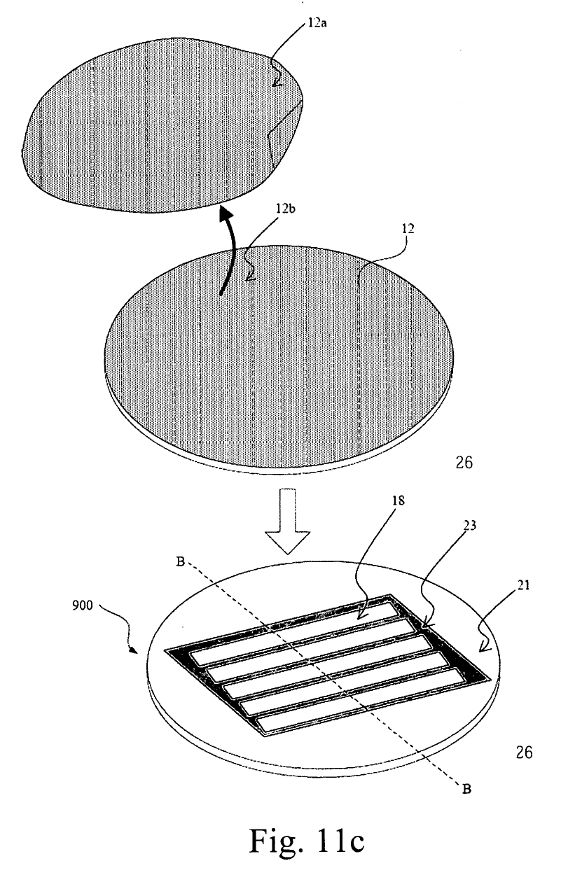

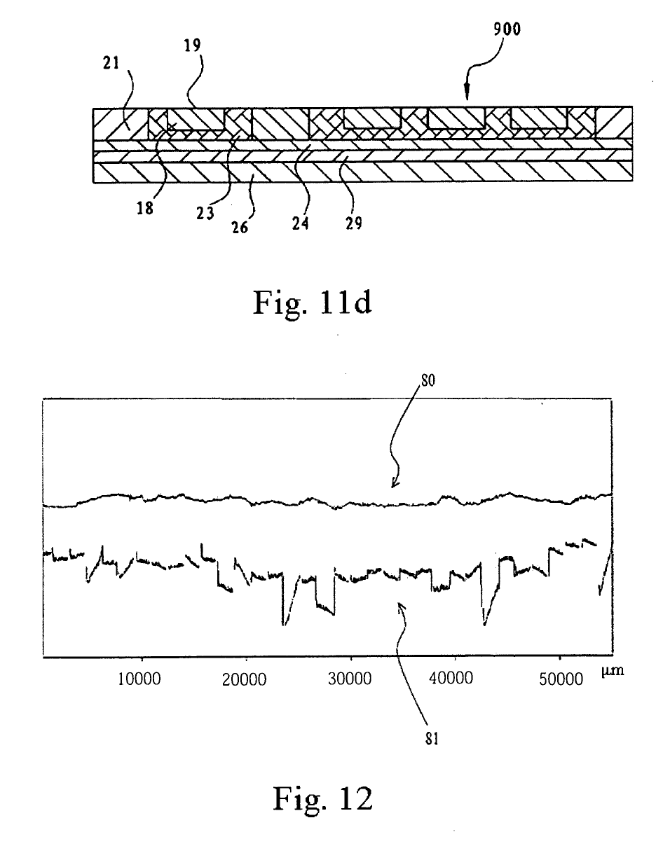

FIGS. 6a-6c illustrate the step 102 of the method above-mentioned. As illustrated, a plurality of slider row bars 18 is attached to the holding device 300. Each slider row bar 18 has a width W1 and a thickness T1. In addition, each slider row bar 18 has a first surface 19 for forming an air bearing surface (ABS-forming surface, also referring to FIG. 11d) and a second surface 182 (slider-mounting surface) opposite to the first surface 19. The first surface 19 is to be processed in a consequent manufacturing process such as a photolithography process so as to form an ABS pattern thereon. In this step, a vacuum pickup head 17 is repeatedly used to hold the slider row bar 18 and move it onto the sticky layer 12b of the film 12. Then, each slider row bar 18 is attached to the sticky layer 12b with its first surface 19 attached to the sticky layer 12b.

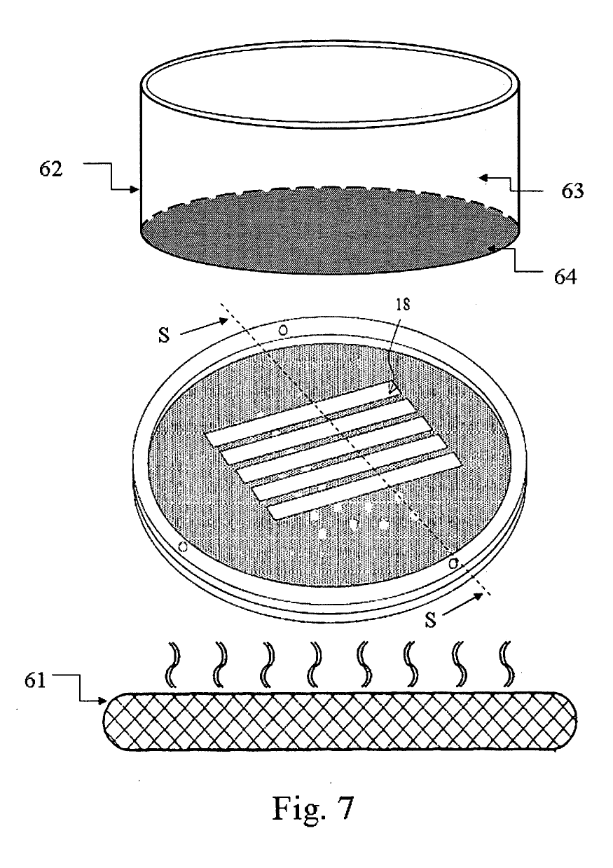

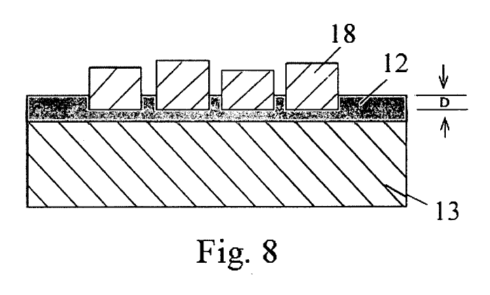

FIGS. 7 and 8 illustrate the step 103 of the method above-mentioned. As illustrated, first the holding device 300 is put on a hot plate 61 to heat the sticky layer 12 so as to soften the sticky layer 12. The temperature of the hot plate 61 is about 50˜110° C., which can be optimized considering time and the properties of sticky layer 12. Then place a sealed cylindrical container 62 which is pre-heated to a temperature as high as the hot plate 61 on the holding device 300. The cylindrical container 62 is fully filled with fluid 63 inside. And there is an elastic thin film 64 at the bottom of the cylindrical container 62 which contacts the second surfaces 182 of the slider row bars 18. Finally remove the cylindrical container 62 and the holding device 300 from the hot plate 61 in sequence and cool the holding device 300 to a temperature near ambient temperature. As shown in FIG. 8, the first surfaces 19 of slider row bars 18 can be pushed into the sticky layer 12 in a depth D about 10˜30 microns under the weight of the cylindrical container 62. Thus, the seepage of the encapsulating glue 23 in the following process to the first surfaces 19 of slider row bars 18 can be eliminated. More important, usually a mixed layer which is hard to be removed exists between the sticky layer 12 and the encapsulating glue 23 because of the sticky layer 12 dissolving in the encapsulating adhesive 23; by pressing and pushing the slider row bars 18 into the sticky layer 12b, the mixed layer can be moved into the spaces between the slider row bars 18, which results in no protrusion or about 2 microns recession between the slider row bars 18.

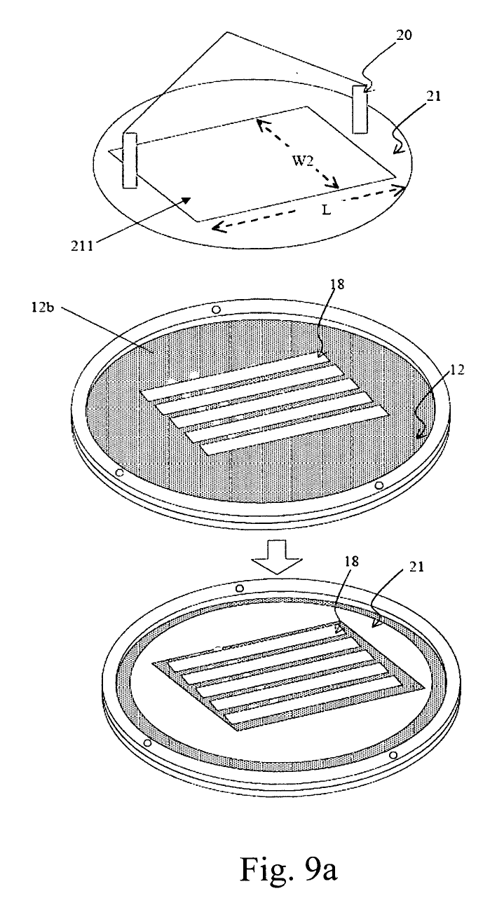

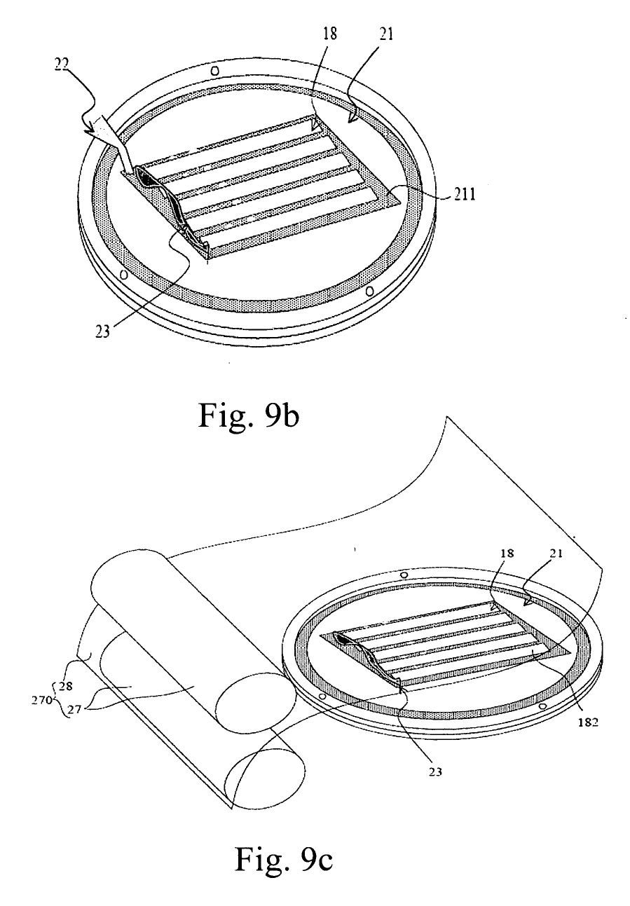

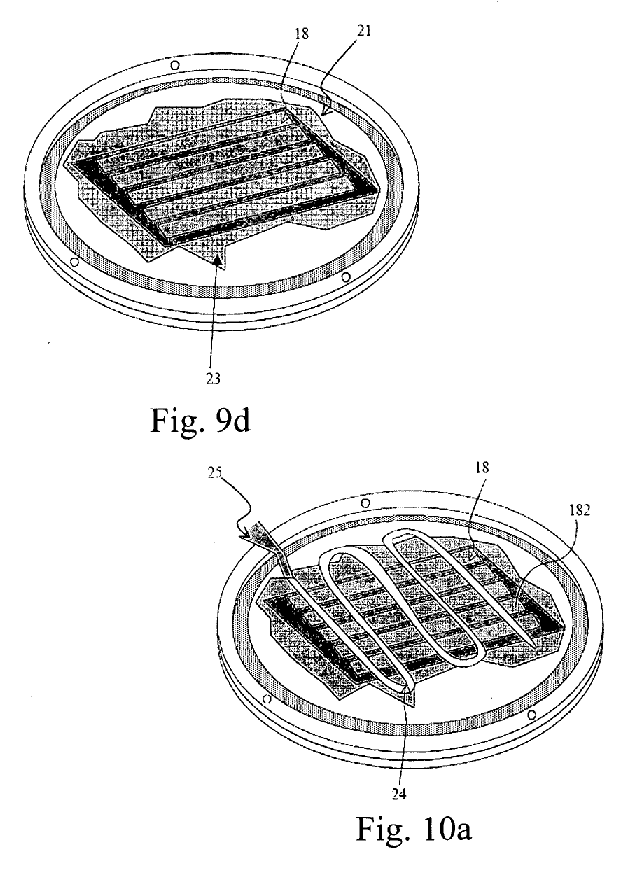

FIGS. 9a-9d show sequential views illustrating the step 104 of the method above-mentioned. Firstly, as shown in FIG. 9a, a glue-restraining plate 21 having an opening 211 is moved by a vacuum pickup head 20 and attached to the sticky layer 12b of the film 12, such that the slider row bars 18 held on the sticky layer 12b are exposed from the opening 211. Then, as shown in FIG. 9b, a kind of encapsulating glue 23, such as cyanoacrylate, is dispensed into the opening 211 by a dispenser 22. Next, as shown in FIGS. 9c-9d, the encapsulating glue 23 dispensed in the opening 211 is laminated such that it flows evenly into all spaces defined between the slider row bars 18. The laminating process is performed by a laminator 270. More specifically, the laminator 270 is constructed by a pair of roller 27 and a liner film 28 disposed between the two rollers 27. Of course, the laminator 270 may has any other suitable structure to perform the above-identified function. When performing the laminating process, the liner film 28 is covered on the second surfaces 182 of the slider row bars 18, while the two rollers 27 roll along the liner film 28 so that the encapsulating glue 23 is squeezed. Finally, the encapsulating glue 23 is cured such that all the slider row bars 18 are bonded together.

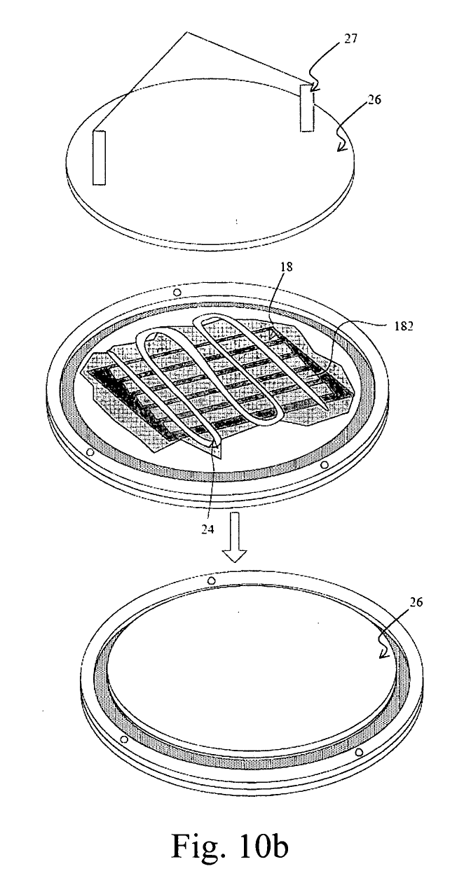

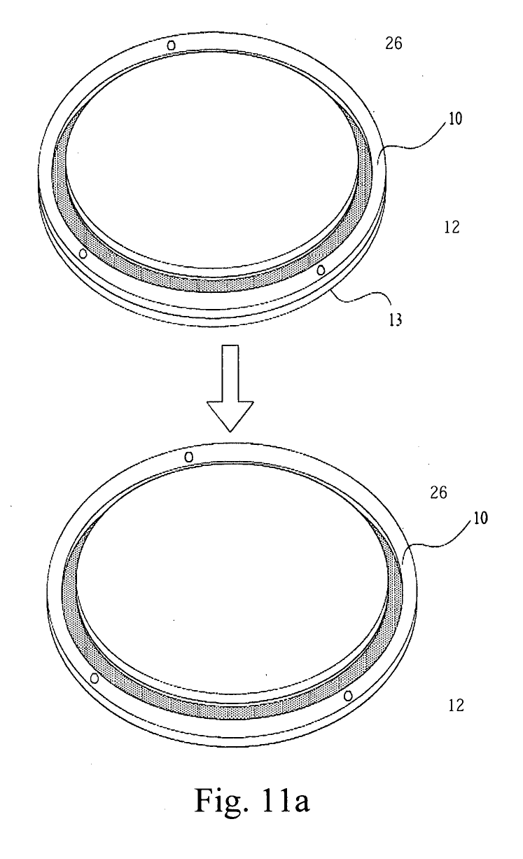

FIGS. 10a-10b show sequential views illustrating the step 105 of the method above-mentioned. Firstly, as shown in FIG. 10a, a kind of fast-curing glue 24 is dispensed on the second surfaces 182 of the slider row bars 18 by a dispenser 25. Then, as shown in FIG. 10b, a carrier 26 is moved by a vacuum pickup head 27 and attached to the second surfaces 182 of the slider row bars 18 via the fast-curing glue 24, such that the entire slider row bars 18 are covered completely by the carrier 26.

In addition, an elastic layer 29 (referring to FIG. 11d) may be sandwiched between the carrier 26 and the slider row bars 18. When the fast-curing glue 24 shrinks due to its nature, a shrinkage stress will be generated. The shrinkage stress will cause the carrier 26 along with the slider row bars 18 held thereon to be deformed negatively. The elastic layer 29 helps to reduce the deformation. In addition, the elastic layer 29 also functions as curing agent of the attaching glue 24 to facilitate the curing process. It is noted that though in the embodiment, an elastic film is used for absorbing the stress; however, this elastic film may be omitted in case that the stress is too weak to be accounted.

FIGS. 11a-11d show sequential views illustrating the step 106 of the method above-mentioned. Firstly, as shown in FIG. 11a, the vacuum transfer fixture 13 is dismounted from the frame 10 to form a combination 800. Preferably, before dismounting the vacuum transfer fixture 13 from the frame 10, the air pressure applied on the film 12 against the protrusion stage 15 of the vacuum transfer fixture 13 (as described before) may be eliminated so as to make the dismounting process easier. Then, as shown in FIG. 11b, the combination 800 is turned upside down such that the non-sticky layer 12a of the film 12 faces upward, and the frame 10 is dismounted. Next, as shown in FIG. 11c, the non-sticky layer 12a of the film 12 is peeled away from the sticky layer 12b, and then the sticky layer 12b is removed from the slider row bars 18 by suitable manner such as resolving method. By removal of the film 12, an encapsulation combination 900 is formed.

FIG. 11d shows a cross-sectional view of the encapsulation combination 900 of FIG. 11c along line B-B. As illustrated, the slider row bars 18 are bonded each other by the encapsulating glue 23 to form a slider row bar assembly, which is restrained by the glue-restraining plate 21. The carrier 26 and the elastic layer 29 are attached to the glue-restraining plate 21 by the fast-curing glue 24. Notably, the first surfaces 19 of the slider row bars 18 are aligned each other perfectly and therefore has a high flatness.

FIG. 12 shows surface scanning characteristics of the ABS-forming surface of the slider row bar assembly formed by one of the conventional methods and method of the invention respectively. As illustrated, curve 80, which represents surface scanning characteristics of the slider row bar assembly of the invention, is smoother greatly than curve 81, which represents surface scanning characteristics of the slider row bar assembly of the conventional method. In other word, utilizing the method of the invention can obtain a more ideal surface flatness of the slider row bar assembly than the conventional method.

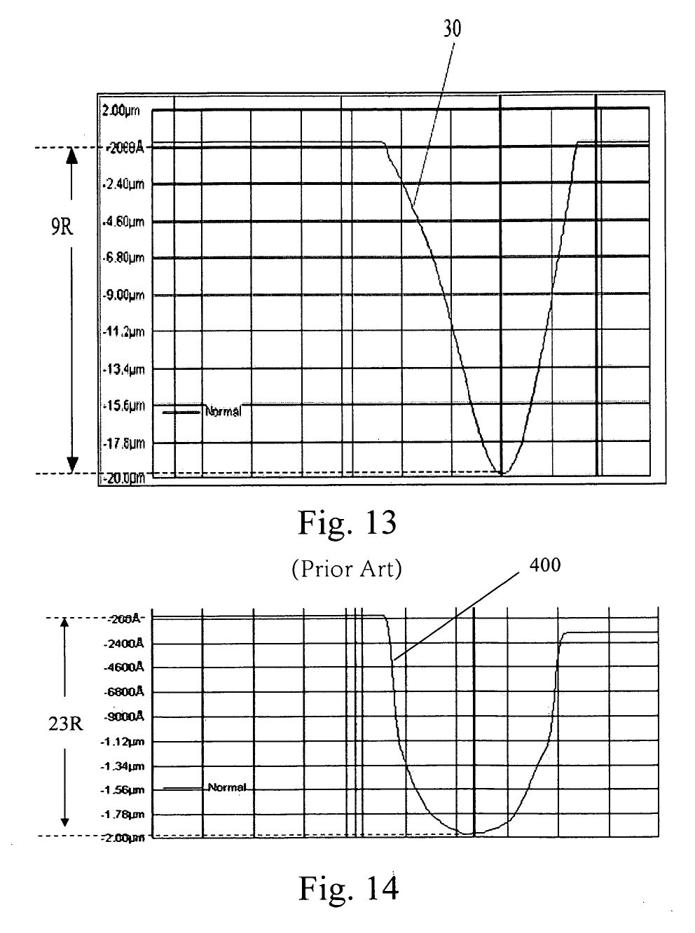

FIG. 14 shows a glue recess 400 formed on the ABS-forming surface of the slider row bars assembly. As illustrated, the depth presented with 23R of the glue recess 400 is only 2 μm, while the depth presented with 9R of the glue recess 30 in conventional method in FIG. 13 are 20 μm. Namely, the slider row bar assembly has shallower glue recesses than that of the conventional method.

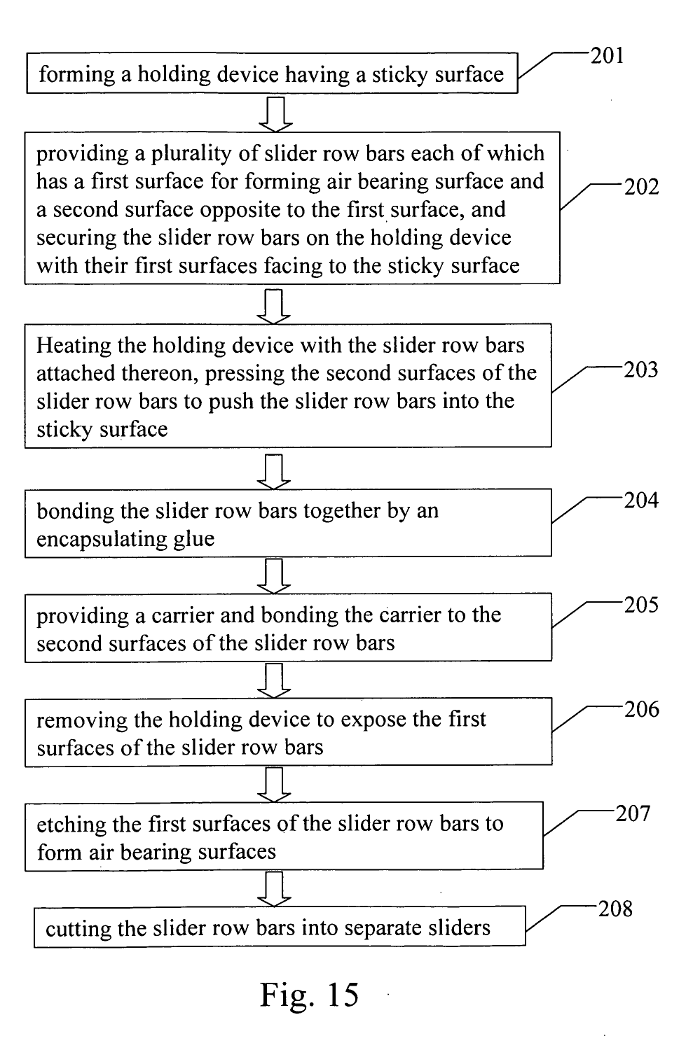

Referring to FIG. 15, a method for manufacturing sliders comprises steps of: forming a holding device having a sticky surface (step 201); providing a plurality of slider row bars each of which has a first surface for forming air bearing surface and a second surface opposite to the first surface, and securing the slider row bars on the holding device with their first surfaces facing to the sticky surface (step 202); heating the holding device with the slider row bars attached thereon, and pressing the second surfaces of the slider row bars to push the slider row bars into the sticky surface (step 203); bonding the slider row bars together by an encapsulating glue to form a slider row bar assembly (step 204); providing a carrier and bonding the carrier to the second surfaces of the slider row bars (step 205); removing the holding device to expose the first surfaces of the slider row bars (step 206); etching the first surfaces of the slider row bars to form air bearing surfaces (step 207); and cutting the slider row bars into separate sliders (step 208).

In comparison with prior art, because it is the ABS-forming surface 19 of the slider row bars 18, not the slider-mounting surfaces thereof are taken as a datum plane, an influence caused by thickness variation of the slider row bars 18 is reduced, or even eliminated completely. In addition, since the ABS-forming surface 19 of the slider row bars 18 are pressed firmly on the protrusion stage 15 of the fixture 13, glue shrinkage at the ABS-forming surfaces is baffled by the protrusion stage 15, and thus glue recess happens mainly at the second surfaces (slider-mounting surfaces) 182 of the row bars 18; and therefore, influence caused by the glue recess 400 on the overall flatness of the ABS-forming surfaces 19 is reduced greatly. Furthermore, the first surfaces 19 of the slider row bars 18 are pushed into the sticky layer 12b, so the possible seepage of the encapsulating glue 23 onto the first surfaces 19 of the slider row bars 18 can be avoided, and a mixed layer existing between the sticky layer 12b and the encapsulating glue 23 can be moved into the spaces between the slider row bars 18, which results in no protrusion between the slider row bars 18. That is to say, the flatness of the ABS-forming surface 19 of the slider row bars assembly (the bonded slider row bars) is improved greatly so that the slider manufacturing by the method of the invention may have an excellent flying stability, and thus the disk drive has a good flying performance and there is no fear that the disk and/or the slider may be damaged.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A method for bonding slider row bars for photolithography process, comprising steps of:
(1) forming a holding device having a sticky surface;
(2) providing a plurality of slider row bars, each of which has a first surface for forming air bearing surface and a second surface opposite to the first surface, and attaching the slider row bars on the holding device with the first surfaces of the slider row bars facing to the sticky surface;
(3) heating the holding device with the slider row bars attached thereon, and pressing the second surfaces of the slider row bars to push the slider row bars into the sticky surface;
(4) bonding the slider row bars together by an encapsulating glue to form a slider row bar assembly;
(5) providing a carrier and bonding the carrier to the second surfaces of the slider row bars; and
(6) removing the holding device.

2. The method according to claim 1, wherein the holding device in the step (1) is formed by steps of:
(a) providing a frame having an hole therein;
(b) providing a film having a sticky layer serving as the sticky surface and a non-sticky layer laminated together with the sticky layer, and covering the film on the frame with the sticky layer facing to the frame;
(c) providing a vacuum transfer fixture having a base plate and a protrusion stage which is protruded from the base plate and has a plurality of vacuum holes defined therein; and
(d) assembling the vacuum transfer fixture to the frame with the protrusion stage received in the hole of the frame and contacting with the non-sticky layer of the film.

3. The method according to claim 2, after the step (1) further comprising a step of evacuating spaces defined between the protrusion stage and the non-sticky layer to generate air pressure to press the film against the protrusion stage.

4. The method according to claim 1, wherein the step (3) comprises steps of:
(a) providing a hot plate and putting the holding device on the hot plate;
(b) providing a container and placing the container on the holding device with a bottom surface of the container contacting the second surfaces of the slider row bars; and
(c) after a period of time, removing the container and the holding device from the hot plate in sequence and cooling the holding device to a temperature near ambient temperature.

5. The method according to claim 4, wherein the container is filled with fluid inside and sealed, and the container has an elastic thin film on the bottom surface thereof which contacts the second surfaces of the slider row bars.

6. The method according to claim 4, wherein before placing the container on the holding device, the container is pre-heated to a temperature as high as the hot plate.

7. The method according to claim 4, wherein the temperature of the hot plate is in the range of from 50˜110° C.

8. The method according to claim 1, wherein the step (4) comprises steps of:
(a) providing a glue-restraining plate having an opening therein and attaching the glue-restraining plate to the sticky surface of the holding device such that the slider row bars are exposed from the opening;
(b) dispensing the encapsulating glue into the opening of the glue-restraining plate;
(c) laminating the encapsulating glue dispensed in the opening of the glue-restraining plate such that the encapsulating glue flows into spaces defined between the slider row bars; and
(d) curing the encapsulating glue such that all the slider row bars are bonded together.

9. The method according to claim 1, wherein the step (5) comprises steps of:
(a) providing a kind of fast-curing glue and dispensing the fast-curing glue to the second surfaces of the slider row bars; and
(b) attaching the carrier to the second surfaces of the slider row bars via the fast-curing glue.

10. The method according to claim 9, wherein an elastic layer is sandwiched between the carrier and the second surfaces of the slider row bars to absorb shrinkage stress generated by the fast-curing glue.

11. A method for manufacturing sliders, comprising steps of:
(1) forming a holding device having a sticky surface;
(2) providing a plurality of slider row bars, each of which has a first surface for forming air bearing surface and a second surface opposite to the first surface, and attaching the slider row bars on the holding device with the first surfaces of the slider row bars facing to the sticky surface;
(3) heating the holding device with the slider row bars attached thereon, and pressing the second surfaces of the slider row bars to push the slider row bars into the sticky surface;
(4) bonding the slider row bars together by an encapsulating glue to form a slider row bar assembly;
(5) providing a carrier and bonding the carrier to the second surfaces of the slider row bars;
(6) removing the holding device to expose the first surfaces of the slider row bars;
(7) etching the first surfaces of the slider row bars to form air bearing surfaces; and
(8) cutting the slider row bars into separate sliders.

12. The method according to claim 11, wherein the holding device in the step (1) is formed by steps of:
(a) providing a frame having an hole therein;
(b) providing a film having a sticky layer serving as the sticky surface and a non-sticky layer laminated together with the sticky layer, and covering the film on the frame with the sticky layer facing to the frame;
(c) providing a vacuum transfer fixture having a base plate and a protrusion stage which is protruded from the base plate and has a plurality of vacuum holes defined therein; and
(d) assembling the vacuum transfer fixture to the frame with the protrusion stage received in the hole of the frame and contacting with the non-sticky layer of the film.

13. The method according to claim 12, after the step (1) further comprising a step of evacuating spaces defined between the protrusion stage and the non-sticky layer to generate air pressure to press the film against the protrusion stage.

14. The method according to claim 11, wherein the step (3) comprises steps of:
(a) providing a hot plate and putting the holding device on the hot plate;
(b) providing a container and placing the container on the holding device with a bottom surface of the container contacting the second surfaces of the slider row bars; and
(c) after a period of time, removing the container and the holding device from the hot plate in sequence and cooling the holding device to a temperature near ambient temperature.

15. The method according to claim 14, wherein the container is filled with fluid inside and sealed, and the container has an elastic thin film on the bottom surface thereof which contacts the second surfaces of the slider row bars.

16. The method according to claim 14, wherein before placing the container on the holding device, the container is pre-heated to a temperature as high as the hot plate.

17. The method according to claim 14, wherein the temperature of the hot plate is in the range of from 50˜110° C.

18. The method according to claim 11, wherein the step (4) comprises steps of:
(a) providing a glue-restraining plate having an opening therein and attaching the glue-restraining plate to the sticky surface of the holding device such that the slider row bars are exposed from the opening;
(b) dispensing the encapsulating glue into the opening of the glue-restraining plate;
(c) laminating the encapsulating glue dispensed in the opening of the glue-restraining plate such that the encapsulating glue flows into spaces defined between the slider row bars; and
(d) curing the encapsulating glue such that all the slider row bars are bonded together.

19. The method according to claim 11, wherein the step (5) comprises steps of:
(a) providing a kind of fast-curing glue and dispensing the fast-curing glue to the second surfaces of the slider row bars; and
(b) attaching the carrier to the second surfaces of the slider row bars via the fast-curing glue.

20. The method according to claim 19, wherein an elastic layer is sandwiched between the carrier and the second surfaces of the slider row bars to absorb shrinkage stress generated by the fast-curing glue.
